(19) United States
(12) Patent Application Publication
(10) Pub. No.: US 2011/0195163 A1
(43) Pub. Date: Aug. 11, 2011

(54) MCC/Hydrocolloid Stabilizers and Edible Compositions Comprising the Same

(75) Inventors: Gregory R. Krawczyk, Princeton Junction, NJ (US); Domingo C. Tuason, Bensalem, PA (US); Gail A. Fisher, North Catasauqua, PA (US)

(73) Assignee: FMC CORPORATION, Philadelphia, PA (US)

(21) Appl. No.: 13/090,795

(22) Filed: Apr. 20, 2011

Related U.S. Application Data
(62) Division of application No. 11/098,058, filed on Apr. 4, 2005.
(60) Provisional application No. 60/631,807, filed on Nov. 30, 2004.
(60) Provisional application No. 60/559,478, filed on Apr. 5, 2004.

(51) Int. Cl. A23L 1/0534; A23L 3/34; A23L 1/24; A23L 1/187; A23C 9/154; A23L 2/62; A23L 2/66; A23L 2/02

(52) U.S. Cl. 426/321; 426/654; 426/590; 426/605; 426/564; 426/579; 426/580; 426/589; 426/582

(57) ABSTRACT

Stabilizers comprising co-processed MCC and a hydrocolloid, edible compositions comprising the stabilizers, and processes for making the edible compositions are described. Edible compositions may be prepared from a stabilizer comprising MCC and a hydrocolloid, along with a protein source and/or juice. Compositions of the invention may include low pH beverages comprising the MCC stabilizer, a protein source and/or a fruit or vegetable juice or other fruit-flavored liquid, optionally with an additional amount of hydrocolloid and acidulant, sweetener, buffering agents, pH modifiers, or stabilizing salts.

### CROSS-REFERENCE TO RELATED APPLICATIONS

This application claims priority to U.S. Provisional Application No. 60/559,478, filed on Apr. 5, 2004, and U.S. Application No. 60/631,807, filed on Nov. 30, 2004, the disclosures of which are incorporated by reference herein in their entirety

### SUMMARY OF THE INVENTION

The present invention generally relates to stabilizers comprising co-processed MCC and a hydrocolloid, and to edible compositions comprising them. In one aspect, the invention relates to edible compositions comprising a stabilizer prepared from MCC and a hydrocolloid, along with a protein source and/or juice. Preferred compositions are those that are stable, have relatively low pH and/or comprise coprocessed MCC and hydrocolloid. Representative stable compositions of the invention include low pH beverages comprising the MCC stabilizer, a protein source and/or a fruit or vegetable juice or other fruit-flavored liquid, optionally with additional HM pectin and acidulant, sweetener, buffering agents, pH modifiers, or stabilizing salts. In certain embodiments, the MCC/hydrocolloid composition employed is a co-spray dried mixture of MCC and HM pectin in a ratio of 40/60 to 60/40 with inorganic salt added as a processing aid.

### DETAILED DESCRIPTION

The present invention encompasses stabilizers made from co-processed MCC and hydrocolloid, and their use in stable edible low-pH compositions comprising the stabilizer, a protein source, and/or a fruit juice and, optionally, acidulants, sweeteners, buffering agents, pH modifiers, or stabilizing salts. Those skilled in the art will recognize that any number of other components may also be added, for example additional flavorings, colorings, preservatives, pH buffers, nutritional supplements, process aids, and the like. While compositions of stabilizer, protein, and fruit juice are primarily described herein, it will also be recognized that beverages having only protein or only fruit juice in combination with the stabilizer may also be desirable and are fully within the spirit of the present invention. In particular, fruit juices containing solids (such as pulp) and nectars are readily stabilized by adding a co-processed MCC/pectin stabilizer as described herein. In such blends having only juice or only protein, it will be recognized that the composition of the stabilizer and the amount of stabilizer used in the beverage blend may need to be adjusted accordingly to maintain the desired stability results. Such routine adjustment of the composition is fully within the capabilities of one having skill in the art and is within the scope and intent of the present invention.

Stabilizers suitable for use in the present invention and methods for their preparation are described in detail in WO 03/096976, which is incorporated herein by reference. In particular, the stabilizers are a colloidal microcrystalline cellulose (MCC)/hydrocolloid composition in which the hydrocolloid has a heterogeneous distribution of linkages and is intimately mixed with and closely bound to the MCC. Co-processed MCC/hydrocolloid stabilizers are preferred for use in the present invention because of their low viscosity, good mouthfeel, and stability over time. Such stabilizers can be used in edible food products comprising protein and/or fruit or vegetable juice, and can also be used in a variety of other products or applications. Other products and applications for which the MCC/hydrocolloid stabilizers described herein may be used include, but are not limited to, dry mix products (instant sauces, gravies, soups, instant cocoa drinks, etc.), low pH dairy systems (sour cream/yogurt, yogurt drinks, stabilized frozen yogurt, etc.), baked goods, as a bulking agent in non-aqueous food systems and in low moisture food systems, as an excipient for chewable tablets, for taste masking drug actives such as APAP, aspirin, ibuprofen, etc., as a suspending agent, as a controlled release agent in pharmaceutical applications, as a delivery system for flavoring agents and nutraceutical ingredients in food, pharmaceutical, and agricultural applications, as a direct compression sustained release agent, in pharmaceutical dosage forms such as tablets, films, and suspensions, as thickeners, in foams, creams, and lotions for personal care applications, as suspending agents, for use with pigments and fillers in ceramics, colorants, cosmetics, and oral care, and in industrial applications such as ceramics, delivery systems for pesticides including insecticides, and in other agricultural products.

Any hydrocolloid that will impart an increased surface charge when used in combination with MCC to produce colloidal MCC compared to colloidal MCC alone may be employed in the stabilizers used in the present invention. Such hydrocolloids include, but are not limited to, seaweed polysaccharides such as carrageenan, agar, furcellaran, alginate, and alginate derivatives such as propylene glycol alginate (PGA) and monovalent salts of alginates such as the potassium and sodium salts, plant gums including galactomannans such as guar, locust bean gum, and tara, carboxymethyl guar, carboxymethyl locust bean gum, glucomannans such as konjac, tamarind seed, polysaccharide, pectins, including high and low methoxyl pectins and acetylated pectins such as beet pectin, karaya, acacia, tragacanth, starch, bacterial polysaccharides such as xanthan and pullulan, gellan and wellan, cellulose gums, alkyl cellulose ethers including methyl cellulose, hydroxypropylmethyl cellulose, hydroxyethyl cellulose, hydroxymethyl cellulose and hydroxypropyl cellulose, and mixtures thereof. The carrageenans may include mu, kappa, kappa-2, nu, iota, lambda, theta, and mixtures thereof In one embodiment of the invention, the hydrocolloid is pectin or PGA.

Any microcrystalline cellulose may be employed in the compositions of the present invention. Suitable feedstocks include, for example, wood pulp such as bleached sulfite and sulfate pulps, corn husks, bagasse, straw, cotton, cotton linters, flax, kemp, ramie, fermented cellulose, etc. In one embodiment of the present invention, the MCC used is one approved for human consumption by the United States Food and Drug Administration.

The use of a processing agent or agents may be desirable during preparation of the MCC/hydrocolloid stabilizer. In one embodiment, for example, in MCC/pectin or MCC/PGA stabilizers, an anti-slip agent or non-lubricant material is used which functions in combination with the hydrocolloid. The anti-slip agent may be, for example, an organic or inorganic salt which is soluble in water. Examples of suitable salts include, but are not limited to, sodium chloride, potassium chloride, calcium chloride, calcium lactate, calcium tartrate, calcium citrate, calcium maleate, calcium monophosphate, and magnesium chloride. Other potential processing agents suitable for use in the present invention include, for example, pH modifiers, such as, for example, ammonium hydroxide, or buffering agents, such as, potassium carbonate, etc. The amount of processing agent used will depend upon the hydrocolloid used and the stabilizer composition. In one embodiment, a salt is used in an amount of about 0.5% to about 5% by weight. In a further embodiment, the amount of salt used is between about 2 and about 4% by weight of the finished dried ingredient composition. In certain embodiments, the pH modifier or buffering agent is added during production of the stabilizer after the shear step but prior to drying step.

The composition of the MCC/hydrocolloid stabilizer may be varied over a wide range in order to impart the desired results to the resulting edible composition or other application. In one embodiment, the ratio of MCC to hydrocolloid is in the range from about 30/70 to about 90/10 parts by weight. In further embodiments, the ratio is about 35/65, about 40/60, about 45/55, about 50/50, about 55/45, about 60/40, about 65/35, about 69/31, about 70/30, or about 85/15.

Suitable juices for use in the present invention include fruit juices (including but not limited to lemon juice, lime juice, and orange juice, including variations such as lemonade, limeade, or orangeade, white and red grape juices, grapefruit juice, apple juice, pear juice, cranberry juice, blueberry juice, raspberry juice, cherry juice, pineapple juice, pomegranate juice, mango juice, apricot juice or nectar, strawberry juice, kiwi juice, and naranjadas) and vegetable juices (including but not limited to tomato juice, carrot juice, celery juice, beet juice, parsley juice, spinach juice, and lettuce juice). The juices may be in any form, including liquid, solid, or semi-solid forms such as gels or other concentrates, ices or sorbets, or powders, and may also contain suspended solids. In another embodiment, fruit-flavored or other sweetened substances, including naturally flavored, artificially flavored, or those with other natural flavors (“WONF”), may be used instead of fruit juice. Such fruit flavored substances may also be in the form of liquids, solids, or semi-solids, such as powders, gels or other concentrates, ices, or sorbets, and may also contain suspended solids.

Proteins suitable for use in the present invention include food proteins and amino acids, which are beneficial to mammals, birds, reptiles, fish, and other living organisms. Food proteins include animal or plant proteins and fractions or derivatives thereof. Animal derived proteins include milk and milk derived products, such as heavy cream, light cream, whole milk, low fat milk, skim milk, fortified milk including protein fortified milk, processed milk and milk products including superheated and/or condensed, sweetened or unsweetened skin milk or whole milk, dried milk powders including whole milk powder and nonfat dry milk (NFDM), casein and caseinates, whey and whey derived products such as whey concentrate, delactosed whey, demineralized whey, whey protein isolate. Egg and egg-derived proteins may also be used. Plant derived proteins include nut and nut derived proteins, sorghum, legume and legume derived proteins such as soy and soy derived products such as untreated fresh soy, fluid soy, soy concentrate, soy isolate, soy flour, and rice proteins, and all forms and fractions thereof. Food proteins may be used in any available form, including liquid, condensed, or powdered. When using a powdered protein source, however, it may be desirable to prehydrate the protein source prior to blending with MCC/pectin stabilizer and juice for added stability of the resulting beverage. When protein is added in conjunction with a fruit or vegetable juice, the amount used will depend upon the desired end result. Typical amounts of protein range from about 1 to about 20 grams per 8 oz. serving of the resulting stable edible composition, but may be higher depending upon the application.

The use of additional hydrocolloids as an adjunct stabilizer may also be desirable, depending upon the preferred application and ingredients used in the edible compositions described herein. Such additional hydrocolloids may include, but are not limited to pectins, including high methoxyl (“HM”) and low methoxyl pectins and acetylated pectins such as beet pectin, high degree-of-substitution (“high DS”) carboxy methyl cellulose (“CMC”), xanthan gum, arabic gum, gellan gum, PGA, carrageenan, tragacanth, starch, galactomannans, such as guar gum, locust bean gum, tara gum, cassia gum, and mixtures thereof.

Such additional hydrocolloids may be employed in a number of ways. In certain embodiments, the additional hydrocolloid may be added to the dry blend or to the slurry during production of the MCC/hydrocolloid stabilizers described herein. For example, the hydrocolloid may be added to the slurry just prior to spray drying, so that the entire mixture is spray-dried at once. The resulting dry mixture of MCC/hydrocolloid plus additional hydrocolloid may then be packaged and stored, and added as a single measure during production of the edible food products described herein. In alternative embodiments, the additional amount of hydrocolloid may be added in a supplementary step at the time of production, in an amount suited to the particular product being manufactured. In either case, the additional hydrocolloid is employed in an amount sufficient to reduce serum separation in the final product.

When manufacturing edible products or beverages having both a low-pH phase and a protein phase, the MCC/hydrocolloid described herein may be added to either the low-pH phase or the protein phase and the additional amounts of hydrocolloid may also be added to either the low-pH phase or the protein phase. It is possible that increased stability may be achieved by adding both the initial MCC/hydrocolloid stabilizer and additional hydrocolloid amounts to only the low-pH phase.

Alternatively, it is also possible to achieve a desirable level of stability by manufacturing edible products or beverages in a single phase. In such a single-phase process, the MCC/hydrocolloid and optional additional amounts of hydrocolloid may be dispersed in water. Additional ingredients, including but not limited to proteins, fruit juices, acidulants, buffers, sweeteners, pH modifiers, antifoaming agents, and salts may then be added to the MCC/hydrocolloid blend in a single phase. The order of addition of any additional ingredients should be selected to insure protein protection both during assembly of the edible product or beverage and thereafter.

Additional ingredients may be added to the edible compositions of the present invention. Such additional ingredients which may be desirable include, but are not limited to, pH modifiers such as acidulants (including citric, malic, tartaric, phosphoric, acetic, and lactic acids and the like), buffering agents (including carbonates, citrates, phosphates, sulfates, maleates, and the like), or the like that may be added to either the juice or protein components at any stage of production, sweeteners (such as sugar, corn syrup, fructose, etc), high intensity sweeteners (such as aspartame), sweetener alternatives (such as sucralose) or sugar alcohols (such as sorbitol, mannitol, and maltitol). In one embodiment of the invention, a sugar alternative such as sucralose, aspartame, or acesulfame K is used to produce a resulting composition that is low in carbohydrate content. Further possible additives include flavors, colorants, emulsifiers, preservatives, fillers such as maltodextrins, alcohol compositions, concentrates, and nutritional additives (such as calcium, i.e. calcium maleate or other minerals, vitamins, herbal supplements, etc.). Optional process aids such as an antifoam agent may also be used in these applications.

The compositions of the present invention are preferably low pH liquids, wherein the resulting pH is greater than about 2.5 and less than about 7.0. In one embodiment, the pH of the composition is between about 2.8 and about 6.5. In a further embodiment, the pH of the composition is between about 3.0 and about 6.0. The pH of the present invention may also be less than about 5.5. The compositions of the present invention may be either alcoholic or non-alcoholic in nature.

The final beverage compositions may be processed by heat treatment in any number of ways. These methods may include, but are not limited to, pasteurization, ultra pasteurization, high temperature short time pasteurization (“HTST”), and ultra high temperature pasteurization (“UHT”). These beverage compositions may also be retort processed, either by rotary retort or static retort processing. Some compositions, such as juice-added or natural or artificially flavored soft drinks may also be cold processed. Many of these processes may also incorporate homogenization or other shearing methods. There may also be co-dried compositions, which can be prepared in dry-mix form, and then conveniently reconstituted for consumption as needed. The resulting beverage compositions may be refrigerated and stored for a commercially acceptable period of time. In the alternative, the resulting beverages may be stored at room temperature, provided they are filled under aseptic conditions.

The edible compositions of the present invention are desirable because they provide enhanced storage stability, and therefore greater commercial appeal. Stable compositions according to the invention are those that exhibit acceptable levels of storage stability. Storage stability, in turn, is intended to mean at least one or more of the following product characteristics over the desired shelf life of the product: in liquid systems, minimal or no sedimentation, minimal or no serum separation, minimal or no creaming, minimal or no mottling, absence of rippling, absence of localized gels or gelation; in solid, semi-solid, gel, foam or film systems, minimal or no serum separation, deaeration or coalescence; and additionally for frozen systems, reduction or avoidance of the growth in size or number of ice crystals. As used in the foregoing description, minimal sedimentation means that any sediment that exists is present as loose sediment, which may be easily shaken back into the system. As used in the foregoing description, minimal serum separation means that less than 5 mm of serum is present when the liquid system is viewed in a 250 mL flask.

### EXAMPLES

The invention is further demonstrated in the following examples. The examples are for purposes of illustration and are not intended to limit the scope of the present invention.

### Manufacture of MCC/Hydrocolloid Compositions

### Example 1

60/40 MCC/Pectin composition

In a 5 gal Hobart mixer, 1391.7 grams of microcrystalline cellulose (MCC) wetcake was admixed with 432.7 grams AMD 783 Pectin to obtain an MCC to AMD 783 Pectin solids ratio of 60/40 parts by weight. 100 grams of a 30% solution of CaCl₂ was added and mixed for several minutes. The admixture was passed through a co rotating twin-screw extruder several times to shear the admixture and comminute the microcrystalline aggregates. The resulting consistency of the extrudate was not slippery thereby enabling it to be subjected to a high work profile which facilitated the formation of colloidal microcrystalline cellulose particles.

288.66 grams of the MCC/AMD 783 Pectin extrudate was dispersed in 2,711.34 grams of distilled water. 2.35 g Potassium Carbonate was added to the slurry for pH adjustment. The resulting slurry was passed through a Manton Gaulin homogenizer at 2,500 psi (2000 psi, 500 psi) and spray dried to form a powder. The spray drying was performed as follows: The homogenized slurry was fed to a 3 foot (0.9144 m) Bowen spray dryer utilizing nozzle atomization 0.1 inch (0.00254 m) opening. The slurry was fed to the dryer by means of a variable feed Moyno pump at a rate to provide the desired outlet temperature. The operating inlet/outlet air temperature of the spray dryer was about 225° C./125° C. The spray drying conditions were regulated depending upon feed properties such as viscosity and resulting dried product characteristics and subsequent yield.

A water dispersible colloidal MCC powder having a very fine colloidal particle size distribution was obtained. Particle size analysis by laser light diffraction showed that the powder had a median particle size of 5.6 microns. When dispersed in deionized water, its 2.6% dispersion exhibited an initial Brookfield viscosity of 1,250 cps and a viscosity of 2,050 cps when retested after 24 hours suggesting an effective interaction, i.e. , a good gel network between the MCC and the AMD 783 Pectin.

### Example 2

50/50 MCC/Pectin Composition

In a 5 gal Hobart mixer, 695.8 grams of microcrystalline cellulose (MCC) wetcake was admixed with 324.6 grams of AMD 783 Pectin to obtain an MCC to AMD 783 Pectin solids ratio of 50/50 parts by weight. 60 grams of a 30% solution of CaCl₂ was added and mixed for several minutes. The admixture was passed through a co rotating twin-screw extruder several times to shear the admixture and comminute the microcrystalline aggregates. The resulting consistency of the extrudate was not slippery thereby enabling it to be subjected to a high work profile which facilitated the formation of colloidal microcrystalline cellulose particles.

270.10 grams of the MCC/AMD 783 Pectin extrudate was dispersed in 2,729.90 grams of distilled water. 3.15 g Potassium Carbonate was added to the slurry for pH adjustment. The resulting slurry was passed through a Manton Gaulin homogenizer at 2,500 psi and spray dried to form a powder. The spray drying was performed as follows: The homogenized slurry was fed to a 3 foot (0.9144 m) Bowen spray dryer utilizing nozzle atomization 0.1 inch (0.00254 m) opening. The slurry was fed to the dryer by means of a variable feed Moyno pump at a rate to provide the desired outlet temperature. The operating inlet/outlet air temperature of the spray dryer was about 225° C./125° C. The spray drying conditions were regulated depending upon feed properties such as viscosity and resulting dried product characteristics and subsequent yield.

A water dispersible colloidal MCC powder having a very fine colloidal particle size distribution was obtained. Particle size analysis by laser light diffraction showed that the powder had a median particle size of 5.1 microns. When dispersed in deionized water, its 2.6% dispersion exhibited an initial Brookfield viscosity of 1,375 cps and a viscosity of 2,350 cps when retested after 24 hours suggesting an effective interaction, i.e., a good gel network between the MCC and the AMD 783 Pectin.

### Example 3

40/60 MCC/Pectin composition

In a 5 gal Hobart mixer, 550.9 grams of microcrystalline cellulose (MCC) wetcake was admixed with 385.5 grams of AMD 783 Pectin to obtain an MCC to AMD 783 Pectin solids ratio of 40/60 parts by weight. 80 grams of a 30% solution of CaCl₂ was added and mixed for several minutes. The admixture was passed through a co rotating twin-screw extruder several times to shear the admixture and comminute the microcrystalline aggregates. The resulting consistency of the extrudate was not slippery thereby enabling it to be subjected to a high work profile which facilitated the formation of colloidal microcrystalline cellulose particles.

254.10 grams of the MCC/AMD 783 Pectin extrudate was dispersed in 2,745.90 grams of distilled water. 3.50 g Potassium Carbonate was added to the slurry for pH adjustment. The resulting slurry was passed through a Manton Gaulin homogenizer at 2,500 psi and spray dried to form a powder. The spray drying was performed as follows: The homogenized slurry was fed to a 3 foot (0.9144 m) Bowen spray dryer utilizing nozzle atomization 0.1 inch (0.00254 m) opening. The slurry was fed to the dryer by means of a variable feed Moyno pump at a rate to provide the desired outlet temperature. The operating inlet/outlet air temperature of the spray dryer was about 225° C./125° C. The spray drying conditions were regulated depending upon feed properties such as viscosity and resulting dried product characteristics and subsequent yield.

A water dispersible colloidal MCC powder having a very fine colloidal particle size distribution was obtained. Particle size analysis by laser light diffraction showed that the powder had a median particle size of 4.7 microns. When dispersed in deionized water, its 2.6% dispersion exhibited an initial Brookfield viscosity of 1,725 cps and a viscosity of 3550 cps when retested after 24 hours suggesting an effective interaction, i.e., a good gel network between the MCC and the AMD 783 Pectin.

### Use of MCC/Hydrocolloid Compositions in the Production of Edible Compositions

### Example 4

A 40:60 composition of MCC/pectin was dispersed in orange juice concentrate and water at 160° F. and mixed for 5 minutes. Additional pectin was then added and mixed until hydrated, or for approximately 5 minutes. Then citric acid was added. Separately, nonfat dry milk powder and sugar were dry blended, then added to the orange juice mixture and mixed for approximately 10 minutes, maintaining a temperature of 160° F. throughout. Next, skim milk was added and all ingredients were mixed for 5 minutes. In one set of experiments, no antifoam was added. In a second set of experiments, an antifoam agent (Hi-Mar S-030-FG at 0.1-0.2%) was added as a process aid to reduce foam generation. The resulting mixture was pasteurized at 195° F. for 15 seconds and homogenized in two stages at 2500 psi (2000 psi, 500 psi). Finally, the mixture was cooled to 70° F. and filled. The MCC/pectin ranged from 0.5-0.75% and amounts of additional HM pectin ranged from 0.15-0.25%, with resulting compositions as follows:

| Formulations @ 3.5 g/8 oz serving | |
|---|---|
| OJ concentrate | 4.21% |
| Sugar | 11.00% |
| Skim Milk | 20.00% |
| Nonfat Dry Milk | 1.73% |
| Citric Acid | 0.25% |
| MCC Pectin (40:60) | 0.5%-0.75% |
| HM Pectin | 0.15%-0.25% |
| Water | to 100% |

The samples were refrigerated and evaluated at 24 hr, 1, 2, and 4 week intervals for viscosity, pH, and stability.

Observations indicated that without the antifoam process aid, the samples exhibited a serum phase separation. However, by shaking the samples, the phases were remixed, which then became stable. The samples with the antifoam process aid were stable initially and remained stable throughout the anticipated shelf life.

The pH of the beverage samples was from 4.1 to 4.2, the viscosity ranged from 12.5 to 38.5 cP, and the stability was perfect or near perfect for samples with 0.625% MCC/HM pectin +0.25% pectin and for 0.75% MCC/HM pectin +0.15%-0.25% pectin. Viscosity was measured using a Brookfield LVT viscometer with the appropriate spindle (usually spindle # 1) at appropriate rpms (usually 60 rpms) at about 10 to 12 rotations. The samples at 0.5% MCC/HM pectin +pectin exhibited 10-19 mm of serum separation in a 250 ml bottle.

### Example 5

A 40:60 composition of MCC/pectin was dispersed in orange juice concentrate and water at 160 ° F. and mixed for 5 minutes. Additional pectin was then added and mixed until hydrated, or for approximately 5 minutes. Then citric acid was added. The temperature of the orange juice mixture was maintained at 160° F. throughout the process. Separately, nonfat dry milk powder and sugar were dry blended, and then added to skim milk at a temperature of 160° F., mixing for approximately 15 minutes and maintaining a temperature of about 160° F. throughout. The milk mixture was then added to the orange juice mixture, and adjustments were made, if needed, for any water loss. An antifoam agent (Hi-Mar S-030-FG at 0.1-0.2%) was then added, and the resulting mixture was pasteurized at 195° F. for 15 seconds and homogenized in two stages at 2500 psi (2000 psi, 500 psi). Finally, the mixture was cooled to 70° F. and filled. The experiment was repeated with a larger amount of dry milk to realize 6 g of milk protein per 8 oz serving. The amount of MCC/pectin ranged from 0.4 to 0.75% and the amount of additional HM pectin ranged from 0.25 to 0.45%, with overall compositions as follows (Pectin alone at 0.45%, 0.75%, and 1% use levels were included in the evaluation for comparison.):

| Formulations @ 3.5 g and 6.0 g | |
|---|---|
| per 8 oz serving | |
| OJ concentrate | 4.21% |
| Sugar | 11.00% |
| Skim Milk | 20.00% |
| Nonfat Dry Milk | 1.73-5.03% |
| Citric Acid | 0.25%-0.45% |
| MCC Pectin (40:60) | 0.4%-0.75% |
| HM Pectin | 0.25%-0.45% |
| Water | To 100% |

The samples were refrigerated and evaluated at 24 hr, 1, 2, and 4-week intervals for viscosity, pH, and stability.

The stability results indicated that formulations ranging from 0.4 to 0.75% MCC/HM pectin +0.25 to 0.45% added HM pectin were entirely stable throughout a 4-week period and are anticipated to be stable throughout the shelf life of the samples. Separate prehydration of the milk powder may have contributed to the overall stability of the finished beverage. Pectin alone at 0.45% was unstable after 24 hours, and pectin alone at 0.75% was unstable after 2 weeks. Both exhibited heavy sediment. Pectin at 1% was stable but was very thick and viscous. At the higher protein level, use of pectin alone exhibited an undesirable ripple upon pouring. Pectin alone, when stability was achieved, was inconsistent with the expected sensory profile of a drinkable beverage.

### Example 6

Samples were prepared generally as in Example 5, but the MCC/HM pectin was used alone without any added pectin. In addition, pectin was used alone at 0.75%, 1.0%, and 1.5% for comparison purposes.

| Formulations @ 3.5 g and 6.0 g | |
|---|---|
| per 8 oz serving | |
| OJ concentrate | 4.21% |
| Sugar | 11.00% |
| Skim Milk | 20.00% |
| Nonfat Dry Milk | 1.73-5.03% |
| Citric Acid | 0.25%-0.45% |
| MCC Pectin (40:60) | 0.5-1.5% |
| Water | to 100% |

The stability results in this set of experiments indicated that acceptable stability was achieved using MCC/HM pectin alone at 0.5 to 1.5%, without any added pectin, for the entire anticipated shelf life. As in Example 5, at use levels of 0.75% pectin alone had heavy sediment after 2 weeks, and at use levels of 1.0% and 1.5% pectin alone, although stable, produced a very thick and viscous finished beverage which was rather inconsistent with the expected drinkable quality of a beverage.

### Example 7

A 40:60 composition of MCC/HM pectin at 0.60% was dispersed in orange juice at 160° F. and mixed for 5 minutes. Additional HM pectin at 0.10% was then added and mixed until hydrated, or for approximately 5 minutes. Then citric acid at 0.33% was added. Separately, soy protein isolate at 1.5% dry blended with sugar (11%) was added to available water at 160° F. and mixed for approximately 5 minutes. This phase was combined with the orange juice mixture and mixed for approximately 10 minutes, maintaining a temperature of 160° F. throughout. The resulting mixture was pasteurized at 195° F. for 15 seconds and homogenized in two stages at 2500 psi (2000 psi, 500 psi). Finally, the mixture was cooled to 70° F. and filled. The finished beverage was refrigerated and evaluated at 24 hrs, 1, 2, and 4 weeks intervals for viscosity, pH, and stability. The finished beverage had a viscosity of 16 cps and had good suspension stability at pH 4.1 after 24 hrs, 1, 2, and 4-weeks storage.

### Example 8

A 60:40 composition of MCC/propylene glycol alginate low DE at 0.50% was dispersed in half of the available water at 160° F. for 3 minutes. In another container, dipotassium phosphate was dispersed first in the remaining available water at 160° F. followed by the addition of soy protein isolate at 1.5%. The two phases (MCC and soy protein isolate dispersions) were blended together followed by the addition of sugar, orange juice, and citric acid. The beverage was heated to approx 195° F. for 45 minutes prior to homogenization, and then homogenized in two stages at 2000 psi and 500 psi. The beverages were cooled to 77° F. and then capped and stored at refrigeration conditions (40° F.). The finished beverage was evaluated at 24 hrs and 1, 2, 4 and 8-week intervals for viscosity, pH, and stability. The finished beverage had a viscosity of 16 cps and had good suspension stability at pH 4.1 after 24 hrs and 1, 2, 4, and 8-weeks storage.

### Example 9

A 40:60 MCC/HM pectin sample was prepared using 3.0% CaCl₂.

| Formulations @ 3.5 g/8 oz serving | |
|---|---|
| OJ concentrate | 4.21% |
| Sugar | 8.00% |
| Skim Milk | 20.00% |
| Nonfat Dry Milk | 1.73% |
| Citric Acid | 0.25% |
| MCC Pectin (40:60) | 0.75-1.0% |
| Water | to 100% |

A 40:60 composition of MCC/pectin was dispersed in orange juice concentrate and water and mixed for 5 minutes. The mixture was heated to 150-155° F. and mixed for 10-20 min until dispersed. Then citric acid was added. The mixture was cooled to 110° F. Separately, nonfat dry milk powder and sugar were dry blended, then added to skim milk. The skim milk mixture was slowly heated to 145-150° F. and mixed for 20 min. Both phases were cooled to 110° F. The milk mixture was then added to the orange juice mixture, and adjustments were made, if needed, for any water loss. An antifoam agent (Hi-Mar S-030-FG at 0.1-0.2%) was then added, and the resulting mixture was pasteurized at 195° F. for 15 seconds and homogenized in two stages at 3000 psi (2500 psi, 500 psi). Finally, the mixture was cooled to 70° F. and filled. At a 0.75% use level, the finished beverage had a pH of 4.07 and a viscosity of 35 cP. The beverage demonstrated acceptable stability after 4 weeks with only 4 mm of serum and no sedimentation. At a 1.0% use level, the finished beverage had a pH of 4.09 and a viscosity of 73 cP. The beverage demonstrated acceptable stability after 4 weeks with only 3 mm of serum and no sedimentation.

### Example 10

A 50:50 MCC/HM pectin sample was prepared using 3.0% CaCl₂.

| Formulations @ 3.5 g/8 oz serving | |
|---|---|
| OJ concentrate | 4.21% |
| Sugar | 8.00% |
| Skim Milk | 20.00% |
| Nonfat Dry Milk | 1.73% |
| Citric Acid | 0.25% |
| MCC Pectin (50:50) | 1.0% |
| Water | to 100% |

A 50:50 composition of MCC/pectin was dispersed in orange juice concentrate and water and mixed for 5 minutes. The mixture was heated to 150-155° F. and mixed for 10-20 min until dispersed. Then citric acid was added. The mixture was cooled to 110° F. Separately, nonfat dry milk powder and sugar were dry blended, then added to skim milk. The skim milk mixture was slowly heated to 145-150° F. and mixed for 20 min. Both phases were cooled to 110° F. The milk mixture was then added to the orange juice mixture, and adjustments were made, if needed, for any water loss. An antifoam agent (Hi-Mar S-030-FG at 0.1-0.2%) was then added, and the resulting mixture was pasteurized at 195° F. for 15 seconds and homogenized in two stages at 3000 psi (2500 psi, 500 psi). Finally, the mixture was cooled to 70° F. and filled. At a 1.0% use level, the finished beverage had a pH of 4.14 and a viscosity of 70 cP. The beverage demonstrated acceptable stability after 8 weeks with only 4 mm of serum and no sedimentation.

### Example 11

Samples were prepared using 0.4% of a 60:40 MCC/HM pectin with 0.35% of added HM pectin.

| Formulations @ 3.5 g/8 oz serving | |
|---|---|
| OJ concentrate | 4.21% |
| Sugar | 8.00% |
| Skim Milk | 20.00% |
| Nonfat Dry Milk | 1.73% |
| Citric Acid | 0.25% |
| MCC Pectin (60:40) | 0.4% |
| HM Pectin | 0.35% |
| Water | to 100% |

A 60:40 composition of MCC/pectin was dispersed in orange juice concentrate and water at 150-155° F. and mixed for 10 minutes. Additional pectin was then added and mixed until hydrated, or for approximately 5 minutes. Then citric acid was added. The temperature of the orange juice mixture was maintained at 145-155° F. throughout the process. The product was cooled to 80-90° F. Separately, nonfat dry milk powder and sugar were dry blended, and then added to skim milk. The mixture was heated to 145-150° F., mixed for approximately 20 minutes while maintaining a temperature of about 145-150° F. throughout. This mixture was also cooled to 80-90° F. The milk mixture was then added to the orange juice mixture, and adjustments were made, if needed, for any water loss. An antifoam agent (Hi-Mar S-030-FG at 0.1-0.2%) was then added, and the resulting mixture was pasteurized at 195° F. for 15 seconds and homogenized in two stages at 2500 psi (2000 psi, 500 psi). Finally, the mixture was cooled to 70° F. and filled. The product had a pH of 4.1 and viscosity of 38 cP and was stable for 8 weeks with no serum separation or sediment.

### Example 12

Samples were prepared using 0.4% of a 60:40 MCC/HM pectin with 0.35% of added HM pectin.

| Formulations @ 3.5 g/8 oz serving | |
|---|---|
| OJ concentrate | 4.21% |
| Sugar | 8.00% |
| Skim Milk | 20.00% |
| Nonfat Dry Milk | 1.73% |
| Citric Acid | 0.25% |
| MCC Pectin (60:40) | 0.4% |
| HM Pectin | 0.35% |
| Water | to 100% |

A 60:40 composition of MCC/pectin was dispersed in orange juice concentrate and water at 150-155° F. and mixed for 10 minutes. Additional pectin was then added and mixed until hydrated, or for approximately 10 minutes. Then citric acid was added. The temperature of the orange juice mixture was maintained at 145-155° F. throughout the process. The mixture was cooled to 120 -130° F. Separately, nonfat dry milk powder and sugar were dry blended, and then added to skim milk. The mixture was heated to 145-150° F., mixed for approximately 20 minutes while maintaining a temperature of about 145-150° F. throughout. This mixture was cooled to 120-130° F. The milk mixture was then added to the orange juice mixture, and adjustments were made, if needed, for any water loss. An antifoam agent (Hi-Mar S-030-FG at 0.1-0.2%) was then added, and the resulting mixture was pasteurized at 195° F. for 15 seconds and homogenized in two stages at 3000 psi (2500 psi, 500 psi). Finally, the mixture was cooled to 70° F. and filled. The product had a pH of 4.17 and a Brookfield viscosity of 47 cP. The finished beverage was completely stable for 8 weeks with no serum separation and no sedimentation.

### Example 13

Samples were prepared using 0.4% of a 60:40 MCC/HM pectin with 0.35% of added HM pectin.

| Formulations @ 3.5 g/8 oz serving | |
|---|---|
| OJ concentrate | 4.21% |
| Sugar | 8.00% |
| Skim Milk | 20.00% |
| Nonfat Dry Milk | 1.73% |
| Citric Acid | 0.25% |
| MCC Pectin (60:40) | 0.4% |
| HM Pectin | 0.35% |
| Water | to 100% |

A 60:40 composition of MCC/pectin was dispersed in orange juice concentrate and water and mixed for 5 minutes. The mixture was heated to 150-155° F. and mixed for 10-20 min until dispersed. Additional pectin was then added and mixed until hydrated, for approximately 10 minutes. Then citric acid was added. The mixture was cooled to 110° F. Separately, nonfat dry milk powder and sugar were dry blended, then added to skim milk. The mixture was slowly heated to 145-150° F. and mixed for 20 min. Both phases were cooled to 110° F. . The milk mixture was then added to the orange juice mixture, and adjustments were made, if needed, for any water loss. An antifoam agent (Hi-Mar S-030-FG at 0.1-0.2%) was then added, and the resulting mixture was pasteurized at 195° F. for 15 seconds and homogenized in two stages at 3000 psi (2500 psi, 500 psi). Finally, the mixture was cooled to 70° F. and filled. The finished beverage had a pH of 4.2 and viscosity of 45 cP. The product was completely stable for 4 weeks with no serum separation and no sedimentation.

### Example 14

Samples were prepared using 0.4% of a 60:40 MCC/HM pectin with 0.35% of added HM pectin.

| Formulations @ 3.5 g/8 oz serving | |
|---|---|
| OJ concentrate | 4.21% |
| Sugar | 8.00% |
| Skim Milk | 20.00% |
| Nonfat Dry Milk | 1.73% |
| Citric Acid | 0.25% |
| MCC Pectin (60:40) | 0.4% |
| HM Pectin | 0.35% |
| Water | to 100% |

A 60:40 composition of MCC/pectin was dispersed in available water at 145-150° F. and mixed for 15 minutes. Additional pectin was then added and mixed until hydrated, or for approximately 10 minutes. Then skim milk, nonfat dry milk, and sugar were added and the product was mixed for an additional 20 minutes while maintaining a temperature between 145-150° F. The product was then cooled to 100-110° F. The orange juice concentrate and citric acid (50/50 blend) were then added, in order, and mixed for 5 minutes. An antifoam agent (Hi-Mar S-030-FG at 0.1-0.2%) was then added and adjustments were made, if needed, for any water loss. Then the product was pasteurized at 195° F. for 15 seconds, cooled to 165° F., and homogenized in two stages at 2500 psi (2000 psi, 500 psi). Finally, the mixture was cooled to 70° F. and filled. The product had a pH of 4.17 and viscosity of 37 cP and was stable for 6 weeks with no serum separation or sediment.

### Example 15

Samples were prepared using 0.75% of a 60:40 MCC/HM pectin.

| Formulations @ 3.5 g/8 oz serving | |
|---|---|
| OJ concentrate | 4.21% |
| Sugar | 8.00% |
| Skim Milk | 20.00% |
| Nonfat Dry Milk | 1.73% |
| Citric Acid | 0.25% |
| MCC Pectin (60:40) | 0.75% |
| Water | to 100% |

A 60:40 composition of MCC/pectin was dispersed in available water at 145-150° F. and mixed for 15 minutes. Then skim milk, nonfat dry milk, and sugar were added and the product was mixed for an additional 20 minutes while maintaining a temperature between 145-150° F. The product was then cooled to 100-110° F. Then orange juice concentrate and citric acid (50/50 blend) were added, in order, and mixed for 5 minutes. An antifoam agent (Hi-Mar S-030-FG at 0.1-0.2%) was then added and adjustments were made, if needed, for any water loss. Then the product was pasteurized at 195° F. for 15 seconds, cooled to 165° F., and homogenized in two stages at 2500 psi (2000 psi, 500 psi). Finally, the mixture was cooled to 70° F. and filled. The product had a pH of 4.27 and viscosity of 31 cP and was stable for 1 week with no serum separation or sediment.

1. An edible food product comprising:
(a) a stabilizer, wherein the stabilizer comprises co-processed colloidal microcrystalline cellulose and a hydrocolloid; and
(b) protein, fruit juice, vegetable juice, a fruit-flavored substance, or any combination thereof.

2. The food product of claim 1, wherein the ratio of MCC to hydrocolloid is between about 30:70 and about 90:10 by weight.

3. The food product of claim 2, wherein the ratio of MCC to hydrocolloid is between about 35:65 and about 69:31.

4. The food product of claim 3, wherein the ratio of MCC to hydrocolloid is between about 40:60 and about 60:40.

5. The food product of claim 4, wherein the ratio of MCC to hydrocolloid is about 45:55, about 50:50, or about 55:45.

6. The food product of claim 2, wherein the ratio of MCC to hydrocolloid is about 70:30.

7. The food product of claim 2, wherein the ratio of MCC to hydrocolloid is about 85:15.

8. The food product of claim 1, wherein the stabilizer constitutes about 0.01 to about 5% by weight of the food product.

9. The food product of claim 8, wherein the stabilizer constitutes about 0.05 to about 3% by weight of the food product.

10. The food product of claim 9, wherein the stabilizer constitutes about 0.11 to about 1.5% by weight of the food product.

11. The food product of claim 1, further comprising an additional amount of hydrocolloid.

12. The food product of claim 11, wherein additional amount of hydrocolloid is HM pectin, PGA, gellan, high DS CMC, xanthan gum, arabic gum, tragacanth, starch, guar gum, locust bean gum, tara gum, cassia gum, or mixtures thereof.

13. The food product of claim 1, wherein the stabilizer is MCC/ HM pectin.

14. The food product of claim 13, wherein the ratio of MCC to HM pectin is between about 1:1 and about 4:1.

15. The food product of claim 1, wherein the stabilizer is MCC/ PGA.

16. The food product of claim 1, wherein the stabilizer is MCC/ high DS CMC.

17. The food product of claim 1, wherein the stabilizer is MCC/gellan gum.

18.-20. (canceled)

21. The food product of claim 1, wherein the pH of the food product is between about 2.5 and about 7.

22. The food product of claim 21, wherein the pH is between about 2.8 and about 6.

23. The food product of claim 22, wherein the pH is between about 3.0 and about 5.5.

24.-38. (canceled)

39. A process for preparing the composition of claim 1, comprising the steps of:
dispersing the stabilizer in a low-pH phase;
prehydrating dried protein components in a liquid phase;
adding the protein phase to the low-pH phase; and
heat treating and/or homogenizing the resulting composition.

40.-45. (canceled)

46. The food product of claim 1, wherein the food product comprises a beverage.

47. The food product of claim 1, wherein the food product comprises a frozen dessert, dry mix, mayonnaise, salad dressing, sauce, aerated food system, cultured product, pudding, filling, cheesecake, dairy, or confectionery product.

48. A drinkable protein beverage composition comprising a food protein, and 0.01% to 5.0% of a co-processed colloidal MCC/hydrocolloid stabilizer, wherein:
the stabilizer provides storage stability over the desired shelf life of the composition, and
the pH of the composition is between about 2.5 and about 4.5.

49. The composition of claim 48, further comprising an additional amount of hydrocolloid.

50. The composition of claim 48, wherein the amount of stabilizer is from about 0.05% to 3.0%.

51. The composition of claim 50, wherein the amount of stabilizer is from about 0.1% to about 1.5%.

52. The composition of claim 49, wherein the additional amount of hydrocolloid is HM pectin, PGA, gellan, high DS CMC, xanthan gum, arabic gum, tragacanth, starch, guar gum, locust bean gum, tara gum, cassia gum, or mixtures thereof.

53. The composition of claim 48, wherein the stabilizer is MCC/HM pectin in a ratio of between about 3:7 and about 7:3.

54. The composition of claim 53, wherein the ratio is about 2:3 or about 3:2.

55. The composition of claim 48, wherein the stabilizer is MCC/PGA.

56. The composition of claim 48, wherein the stabilizer is MCC/high DS CMC.

57.-59. (canceled)

60. A drinkable beverage composition comprising a fruit juice, vegetable juice, fruit-flavored substance, or a combination thereof, and 0.01% to 5.0% of a co-processed colloidal MCC/hydrocolloid stabilizer, wherein:
the stabilizer provides storage stability over the desired shelf life of the composition, and
the pH of the composition is between about 2.5 and about 4.5.

61. The composition of claim 60, further comprising an additional amount of hydrocolloid.

62. The composition of claim 60, wherein the amount of stabilizer is from about 0.05% to 3.0%.

63. The composition of claim 62, wherein the amount of stabilizer is from about 0.1% to about 1.5%.

64. The composition of claim 61, wherein the additional amount of hydrocolloid is HM pectin, PGA, gellan, high DS CMC, xanthan gum, arabic gum, tragacanth, starch, guar gum, locust bean gum, tara gum, cassia gum, or mixtures thereof.

65. The composition of claim 60, wherein the stabilizer is MCC/HM pectin in a ratio of between about 3:7 and about 7:3.

66. The composition of claim 65, wherein the ratio is about 2:3 or about 3:2.

67. The composition of claim 60, wherein the stabilizer is MCC/PGA.

68. The composition of claim 60, wherein the stabilizer is MCC/high DS CMC.

69.-71. (canceled)

72. An edible composition comprising a liquid food protein, a liquid food protein concentrate, a food protein isolate, a dried food protein, or combinations thereof, and 0.01% to 5.0% of a colloidal MCC/hydrocolloid stabilizer, wherein the stabilizer provides storage stability over the desired shelf life of the composition.

73. A composition comprising co-processed MCC and hydrocolloid, wherein the ratio of MCC to hydrocolloid is between about 30:70 and 70:30.

74. The composition of claim 73, wherein the ratio of MCC to hydrocolloid is between about 35:65 and about 69:31.

75. The composition of claim 74, wherein the ratio of MCC to hydrocolloid is between about 40:60 and about 60:40.

76. The composition of claim 75, wherein the ratio of MCC to hydrocolloid is about 45:55, about 50:50, or about 55:45.

77. The composition of claim 73, further comprising an anti-slip agent.

78. The composition of claim 77, wherein the anti-slip agent is an inorganic salt.

79.-83. (canceled)

84. A process for preparing the composition of claim 1, comprising the steps of:
dispersing the stabilizer in water;
adding the protein and, optionally, other additional ingredients to the stabilizer; and
heat treating and/or homogenizing the resulting composition.

85.-87. (canceled)
